(19) United States
(12) Patent Application Publication
(10) Pub. No.: US 2026/0175803 A1
(43) Pub. Date: Jun. 25, 2026

(54) VEHICLE ELECTRIC POWER SYSTEM

(71) Applicant: TOYOTA JIDOSHA KABUSHIKI KAISHA, Toyota-shi (JP)

(72) Inventor: Satoru TAKEMOTO, Okazaki-shi (JP)

(73) Assignee: TOYOTA JIDOSHA KABUSHIKI KAISHA, Toyota-shi (JP)

(21) Appl. No.: 19/395,266

(22) Filed: Nov. 20, 2025

(30) Foreign Application Priority Data
Dec. 24, 2024 (JP) 2024-227734

(51) Int. Cl. B60R 16/03; H02J 9/06

(52) U.S. Cl. CPC B60R 16/03; H02J 9/061

(57) ABSTRACT

A vehicle electric power system includes a main DC-DC converter and an auxiliary battery, a sub DC-DC converter, a first switch and a second switch that are provided in series between a main power supply system and a sub power supply system, and a controller. The main DC-DC converter and the auxiliary battery are connected to the first load connected to the main power supply system and are configured to supply electric power. The sub DC-DC converter is connected to a second load connected to a sub power supply system and is configured to supply electric power. When a failure occurs in the main DC-DC converter, the controller stops a load that is not required to operate upon the failure and controls the first switch and the second switch such that the electric power is supplied to the first load after the voltage of the sub DC-DC converter is normal.

### CROSS-REFERENCE TO RELATED APPLICATION

This application claims priority to Japanese Patent Application No. 2024-227734 filed on Dec. 24, 2024. The disclosure of the above-identified application, including the specification, drawings, and claims, is incorporated by reference herein in its entirety.

### BACKGROUND

### 1. Technical Field

The present disclosure relates to an electric power system mounted in a vehicle.

### 2. Description of Related Art

Japanese Unexamined Patent Application Publication No. 2023-032346 (JP 2023-032346 A) discloses a vehicle electric power system including a main power supply system to which a main power supply and an auxiliary battery are connected and a sub power supply system to which a sub power supply is connected, the main power supply system and the sub power supply system being electrically connected to each other via a switch. In the vehicle electric power system, in a case where an abnormality occurs in one power supply system, the switch is controlled into a non-conductive state to disconnect the one power supply system, and operation of the vehicle is continued by the other power supply system that is in a normal state.

### SUMMARY

In a case where a failure occurs in the main power supply in the main power supply system, electric power may be supplied as backup from the sub power supply system to the load of the main power supply system. In this case, in a case where a load connected to the sub power supply system that is not to operate during backup remains operating, there is a concern that the electric power supply capability of the sub power supply may be insufficient.

In addition, the output of the sub power supply may be controlled by the DC-DC converter. In this case, upon connection to the main power supply system while the voltage control of the DC-DC converter is not completed, the auxiliary battery of the main power supply system may be overcharged.

The present disclosure has been made in view of the above-described problem, and an object of the present disclosure is to provide a vehicle electric power system that can reduce a possibility that the electric power supply capability of the sub power supply is insufficient and can suppress overcharging of the auxiliary battery.

In order to solve the above-described problem, an aspect of technique of the present disclosure is a vehicle electric power system that supplies electric power to a load mounted in a vehicle. The vehicle electric power system includes: a main DC-DC converter connected to a first load that is connected to a main power supply system, the main DC-DC converter being configured to supply electric power to the first load; an auxiliary battery connected to the first load, the auxiliary battery being configured to supply electric power to the first load; a sub DC-DC converter connected to a second load that is connected to a sub power supply system, the sub DC-DC converter being configured to supply electric power to the second load; a first switch and a second switch provided in series between the main power supply system and the sub power supply system; and a controller configured to control the first switch, the second switch, and the sub DC-DC converter. In a case of a failure of the main DC-DC converter, the controller stops a load that is not to operate in the case of the failure and controls the first switch and the second switch such that the electric power is supplied to the first load after a voltage of the sub DC-DC converter is normal.

According to the vehicle electric power system of the present disclosure, the possibility that the electric power supply capability of the sub power supply is insufficient can be reduced, and overcharging of the auxiliary battery can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of a configuration including a vehicle electric power system according to an embodiment of the present disclosure and peripheral portions thereof;

FIG. 2 is a diagram showing a modification of the sub power supply;

FIG. 3A is a processing flowchart of sub power supply connection control executed by the vehicle electric power system;

FIG. 3B is a processing flowchart of the sub power supply connection control executed by the vehicle electric power system; and

FIG. 4 is a diagram showing an application in which the vehicle electric power system is connected to a load of a zone configuration.

### DETAILED DESCRIPTION OF EMBODIMENTS

In a case where a failure occurs in the main power supply system, the vehicle electric power system according to the present disclosure reduces the load of the auxiliary system to an amount that can be supplied by the auxiliary battery and the sub DC-DC converter. Further, it is confirmed whether a voltage of the sub DC-DC converter is normal, and a relay that connects the sub DC-DC converter and the auxiliary battery is connected.

Hereinafter, an embodiment of the present disclosure will be described in detail with reference to the drawings.

### Embodiment

### Configuration

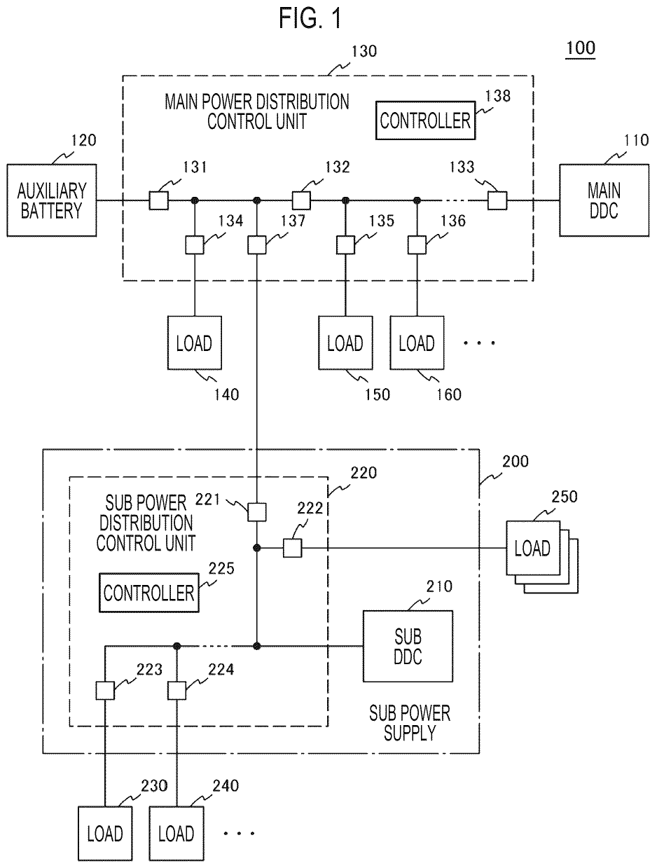

FIG. 1 is a schematic diagram showing an example of a configuration including a vehicle electric power system 100 according to an embodiment of the present disclosure and a peripheral portion thereof. The vehicle electric power system 100 illustrated in FIG. 1 comprises a main DC-DC converter (main DDC) 110, an auxiliary battery 120, and a main power distribution control unit 130 as the main power supply system, and a sub power supply 200 as the sub power supply system. The vehicle electric power system 100 is mounted on a vehicle.

The main DC-DC converter 110 is an electric power converter. The electric power converter converts a voltage (for example, 48 V) of electric power of a high-voltage battery (not shown, such as a lithium ion battery) input from the high-voltage battery into a necessary voltage (for example, 12 V), and outputs the converted voltage to the main power distribution control unit 130.

The auxiliary battery 120 is a secondary battery configured to be chargeable and dischargeable, such as a lithium ion battery. The auxiliary battery 120 can supply the electric power stored therein to the main power distribution control unit 130.

The main power distribution control unit 130 is a configuration (a power distribution ECU or the like) for supplying and controlling the electric power to a plurality of loads 140 to 160 (first load) such as a large number of devices and apparatuses mounted on the vehicle. The electric power supply source (main electric power supply source) is the main DC-DC converter 110 and the auxiliary battery 120. The main power distribution control unit 130 supplies the electric power via a plurality of switches 131 to 137 based on the control of a controller 138. A semiconductor relay is used for the switches 131 to 137. The number and arrangement of the switches 131 to 137 shown in FIG. 1 are examples, and are not limited.

The sub power supply 200 is configured to function as a power supply for the loads 230 to 250. In addition, the sub power supply 200 is configured to function as a power supply that supplies backup electric power in a case where a failure occurs in the main power supply system. The sub power supply 200 includes a sub DC-DC converter (sub DDC) 210 and a sub power distribution control unit 220.

The sub DC-DC converter 210 is an electric power converter. The electric power converter converts the voltage of the electric power of the high-voltage battery (not illustrated) input from the same high-voltage battery as the main DC-DC converter 110 (for example, 48 V) into a required voltage (for example, 12 V), and outputs the converted voltage to the sub power distribution control unit 220.

The sub power distribution control unit 220 is a configuration (a power distribution ECU or the like) for supplying and controlling the electric power to the loads 230 to 250 (second load) using the sub DC-DC converter 210 as an electric power supply source (sub electric power supply source). The sub power distribution control unit 220 supplies the electric power via the switches 221 to 224 based on the control of a controller 225. A semiconductor relay is used as the switches 221 to 224. The number and arrangement of the switches 221 to 224 shown in FIG. 1 are examples, and are not limited.

### Modification

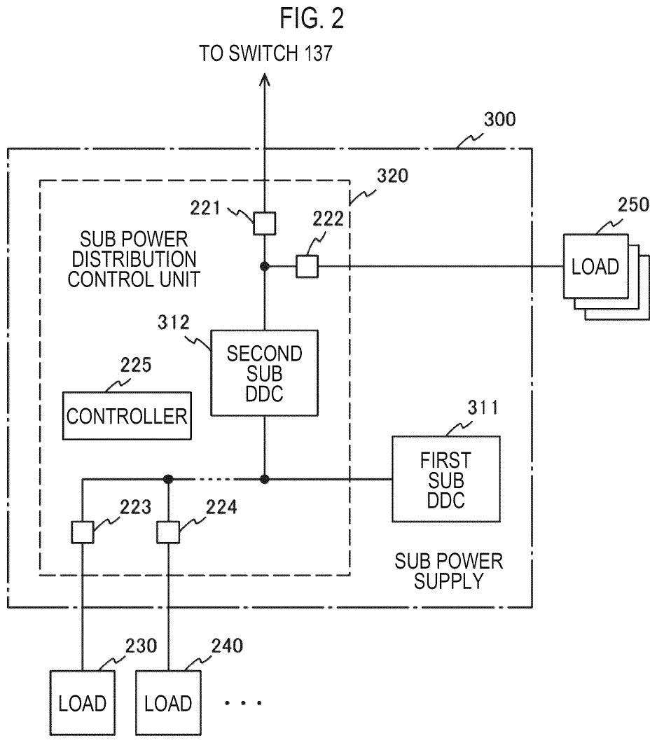

FIG. 2 is a modification in which a sub power supply 300 having a different configuration from the sub power supply 200 is used in the vehicle electric power system 100. The sub power supply 300 according to the modification can be applied to a case in which a load that operates at a different voltage is included in the loads 230 to 250 (second load).

The sub power supply 300 comprises a first sub DC-DC converter (first sub DDC) 311 and a sub power distribution control unit 320. The sub power distribution control unit 320 comprises a second sub DC-DC converter (second sub DDC) 312, the switches 221 to 224, and the controller 225.

The first sub DC-DC converter 311 adjusts the voltage of the electric power input from the high-voltage battery to the voltage (for example, 48 V) required by the loads 230 and 240, and outputs the adjusted voltage to the sub power distribution control unit 320. The second sub DC-DC converter 312 converts the voltage (for example, 48 V) of the electric power input from the first sub DC-DC converter 311 into the voltage (for example, 12 V) required by the load 250.

The sub power supply 300 having the configuration using a plurality of first sub DC-DC converters 311 and second sub DC-DC converters 312 can supply the electric power having the optimum voltage to each of the loads 230 to 250.

### Control

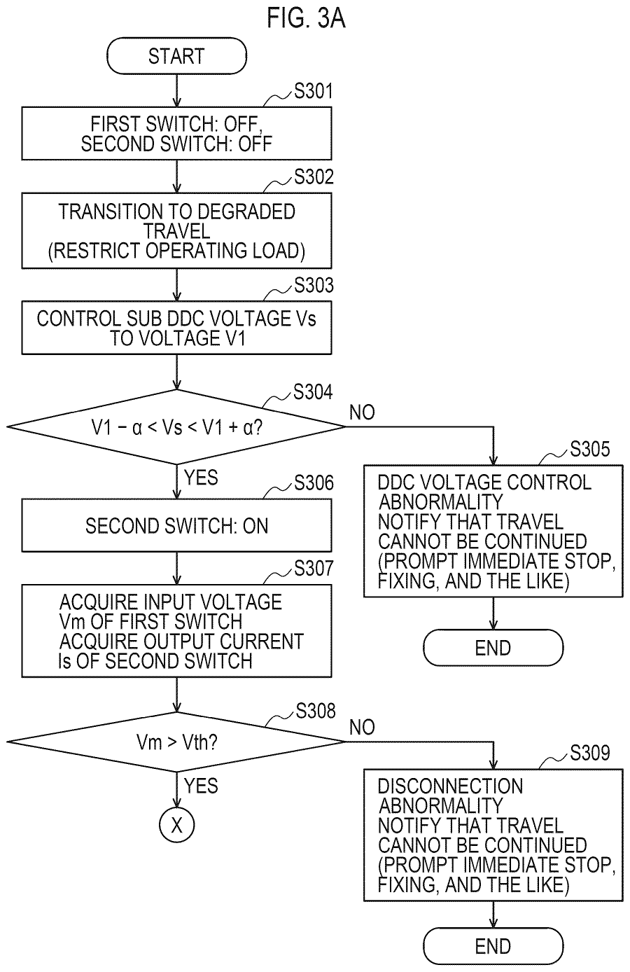

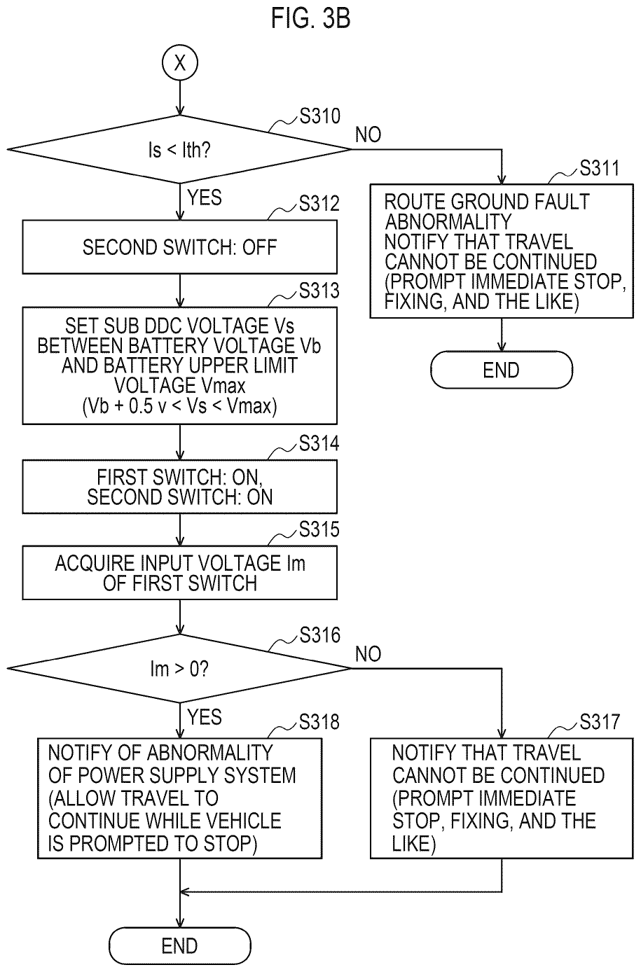

Next, an example of the control executed in the vehicle electric power system 100 according to the embodiment of the present disclosure will be described with reference to FIGS. 3A and 3B. FIGS. 3A and 3B are flowcharts illustrating a processing procedure of the sub power supply connection control executed by the controller 138 of the main power distribution control unit 130 and the controller 225 of the sub power distribution control unit 220 (or 320). The process in FIG. 3A and the process in FIG. 3B are connected by a connector X.

The sub power supply connection control illustrated in FIGS. 3A and 3B is started in a case where the electric power supply from the main DC-DC converter 110 to the main power distribution control unit 130 is stopped due to an abnormality of the main DC-DC converter 110 or the like. In a case where the electric power supply is stopped, the switch 133 is controlled into the non-conductive state by the controller 138.

### S301

The controller 138 controls the switch 137 (hereinafter, referred to as a “first switch 137”) of the main power distribution control unit 130 into the non-conductive (OFF) state. In addition, the controller 225 controls the switch 221 (hereinafter, referred to as a “second switch 221”) of the sub power distribution control unit 220 into the non-conductive (OFF) state. The controller 225 performs the control based on an instruction from the controller 138 that detects the stop of the electric power supply by the main DC-DC converter 110 (the same applies to each step below).

In a case where both the first switch 137 and the second switch 221 are controlled into the non-conductive (OFF) state, the process proceeds to S302.

### S302

The controller 138 and the controller 225 transition to a state where the vehicle is caused to perform the degraded travel. The degraded travel refers to, for example, travel to safely stop the vehicle in which the abnormality has occurred on the road shoulder or the like. In the transition to the degraded travel, the controller 138 performs a process of restricting the load to be operated among the loads 140 to 160 (auxiliary system load) connected to the main power distribution control unit 130 to only the load required for performing the degraded travel. The controller 225 performs a process of restricting the load to be operated among the loads 230 to 250 (sub system load) connected to the sub power distribution control unit 220 to only the load required for performing the degraded travel. As a method of the restriction, the electric power supply to the load may be stopped by controlling the switch into the non-conductive (OFF) state, or the instruction to stop may be given to the load.

In a case where the state of the vehicle transitions to the degraded travel and the operating load is restricted, the process proceeds to S303.

### S303

The controller 225 sets the output voltage (sub DDC voltage Vs) of the sub DC-DC converter 210 to the voltage V1. The voltage V1 can be set to, for example, a voltage (Vb−1 volt) in consideration of the voltage Vf of the transistor used in the semiconductor relay from the output voltage (battery voltage Vb) of the auxiliary battery 120.

In a case where the output voltage (sub DDC voltage Vs) of the sub DC-DC converter 210 is set to the voltage V1, the process proceeds to S304.

### S304

The controller 225 determines whether the output voltage (sub DDC voltage Vs) of the sub DC-DC converter 210 is controlled to the set voltage V1. The determination can be made according to a condition of Expression 1, for example, in a case where a tolerance of the control variation is set to α (0.5 volts or the like).

$$V 1 - α < V s < V 1 + α \qquad [ Expression 1 ]$$

In a case where the output voltage (sub DDC voltage Vs) of the sub DC-DC converter 210 satisfies the condition of Expression 1 (S304: Yes), the process proceeds to S306. On the other hand, in a case where the output voltage (sub DDC voltage Vs) of the sub DC-DC converter 210 does not satisfy the condition of Expression 1 (S304: No), the process proceeds to S305.

### S305

The controller 138 and the controller 225 control such that a notification is issued to the display device of the vehicle or the like that the travel cannot be continued, as an abnormality (DDC voltage control abnormality) is present in the output voltage control of the sub DC-DC converter 210. In addition, the vehicle may be prompted to stop immediately or to be fixed in response to the notification.

In a case where it is notified that the travel cannot be continued in response to the abnormality (DDC voltage control abnormality) of the output voltage control of the sub DC-DC converter 210, the present sub power supply connection control ends.

### S306

The controller 225 controls the second switch 221 of the sub power distribution control unit 220 into a conductive (ON) state. The first switch 137 of the main power distribution control unit 130 remains in the non-conductive (OFF) state.

In a case where the second switch 221 is controlled into the conductive (ON) state, the process proceeds to S307.

### S307

The controller 138 acquires the voltage applied from the sub power distribution control unit 220 to the main power distribution control unit 130. More specifically, the controller 138 acquires the voltage (input voltage Vm) appearing at the first switch 137 end of the wiring connecting the first switch 137 and the second switch 221. In addition, the controller 225 acquires the current supplied from the sub power distribution control unit 220 to the main power distribution control unit 130. More specifically, the controller 225 acquires the current (output current Is) flowing out from the second switch 221 end in the above-described wiring.

In a case where the voltage (input voltage Vm) appearing at the first switch 137 end and the current (output current Is) flowing out from the second switch 221 end are acquired, the process proceeds to S308.

### S308

The controller 138 determines whether the voltage (input voltage Vm) appearing at the first switch 137 end exceeds a predetermined threshold voltage Vth. This determination is performed to determine whether the wiring connecting the first switch 137 and the second switch 221 is disconnected. Therefore, the threshold voltage Vth is set based on the voltage expected to appear at the first switch 137 end in a case where the above-described wiring is disconnected (for example, 3 volts).

In a case where the voltage (input voltage Vm) appearing at the first switch 137 end exceeds the threshold voltage Vth (S308: Yes), the process proceeds to S310. On the other hand, in a case where the voltage (input voltage Vm) appearing at the first switch 137 end does not exceed the threshold voltage Vth (S308: No), the process proceeds to S309.

### S309

The controller 138 and the controller 225 control such that a notification is issued to the display device of the vehicle or the like that the travel cannot be continued, as an abnormality (disconnection abnormality) where the wiring connecting the first switch 137 and the second switch 221 is disconnected. In addition, the vehicle may be prompted to stop immediately or to be fixed in response to the notification.

In a case where the travel cannot be continued in response to the disconnection abnormality (disconnection abnormality) of the wiring connecting the first switch 137 and the second switch 221, the present sub power supply connection control ends.

### S310

The controller 225 determines whether the current (output current Is) flowing out from the second switch 221 end is equal to or less than a predetermined threshold current Ith. This determination is made to determine whether the wiring connecting the first switch 137 and the second switch 221 is grounded. Therefore, the threshold current Ith is set based on the current expected to flow out from the second switch 221 end in a case where the above-described wiring is grounded (for example, 5 amperes).

In a case where the current (output current Is) flowing out from the second switch 221 end is equal to or less than the threshold current Ith (S 310: Yes), the process proceeds to S312. On the other hand, in a case where the current (output current Is) flowing out from the second switch 221 end exceeds the threshold current Ith (S310: No), the process proceeds to S311.

### S311

The controller 138 and the controller 225 control such that a notification is issued to the display device of the vehicle or the like that the travel cannot be continued, as an abnormality (route ground fault abnormality) where the wiring connecting the first switch 137 and the second switch 221 is grounded. In addition, the vehicle may be prompted to stop immediately or to be fixed in response to the notification.

In a case where the travel cannot be continued in response to the ground fault abnormality (route ground fault abnormality) of the wiring connecting the first switch 137 and the second switch 221, the present sub power supply connection control ends.

### S312

The controller 225 controls the second switch 221 of the sub power distribution control unit 220 into the non-conductive (OFF) state. The first switch 137 of the main power distribution control unit 130 remains in the non-conductive (OFF) state.

In a case where the second switch 221 is controlled into the non-conductive (OFF) state, the process proceeds to S313.

### S313

The controller 225 sets the output voltage (sub DDC voltage Vs) of the sub DC-DC converter 210 to a predetermined voltage V2. The predetermined voltage V2 is between the output voltage (battery voltage Vb) of the auxiliary battery 120 and the upper limit voltage (battery upper limit voltage Vmax) for preventing the auxiliary battery 120 from being overcharged. The voltage V2 can be set according to a condition of Expression 2, for example. It should be noted that α is a control variation tolerance.

$$Vb + α < V 2 < Vmax \qquad [ Expression 2 ]$$

In a case where the output voltage (sub DDC voltage Vs) of the sub DC-DC converter 210 is set to the voltage V2, the process proceeds to S314. It should be noted that since there is a response delay of the voltage to the setting, it is desirable to proceed to the process of S314 after confirming that the sub DDC voltage Vs has increased to the voltage V2.

### S314

The controller 138 controls the first switch 137 of the main power distribution control unit 130 into the conductive (ON) state. In addition, the controller 225 controls the second switch 221 of the sub power distribution control unit 220 into the conductive (ON) state.

It should be noted that the control of the first switch 137 and the second switch 221 into the conductive state is performed during the travel of the vehicle. This is to prevent the voltage of the main power distribution control unit 130 from decreasing and the loads 140 to 160 from being reset due to the inrush current flowing from the sub power distribution control unit 220 to the main power distribution control unit 130.

In a case where both the first switch 137 and the second switch 221 are controlled into the conductive (ON) state, the process proceeds to S315.

### S315

The controller 138 acquires the current supplied from the sub power distribution control unit 220 to the main power distribution control unit 130. More specifically, the controller 138 acquires the current (input current Im) flowing into the first switch 137 end in the wiring connecting the first switch 137 and the second switch 221.

In a case where the current (input current Im) flowing into the first switch 137 end is acquired, the process proceeds to S316.

### S316

The controller 138 determines whether the current (input current Im) flowing into the first switch 137 end is not zero “0”. The determination is performed to determine whether the electric power is normally supplied from the sub power supply 200 to the main power distribution control unit 130.

In a case where the current (input current Im) flowing into the first switch 137 end is not zero (S316: Yes), the process proceeds to S318. On the other hand, in a case where the current (input current Im) flowing into the first switch 137 end is zero (S316: No), the process proceeds to S317.

### S317

The controller 138 and the controller 225 control such that a notification is issued to the display device of the vehicle or the like that the travel cannot be continued. In addition, the vehicle may be prompted to stop immediately or to be fixed in response to the notification.

In a case where it is notified that the travel cannot be continued, the present sub power supply connection control ends.

### S318

The controller 138 and the controller 225 control such that a notification is issued that an abnormality is present in the power supply system. In this notification, travel may be allowed to continue while the vehicle is prompted to stop.

In a case where the abnormality of the power supply system is notified, the present sub power supply connection control ends.

### Action and Effect

As described above, the vehicle electric power system 100 according to the embodiment of the present disclosure comprises the main DC-DC converter 110 and the auxiliary battery 120, and the sub DC-DC converter 210. The main DC-DC converter 110 and the auxiliary battery 120 are connected to supply electric power to the loads 140 to 160 (first load) connected to the main power distribution control unit 130. The sub DC-DC converter 210 is connected to supply electric power to the loads 230 to 250 (second load) connected to the sub power distribution control unit 220. In a case where a failure occurs in the main DC-DC converter 110, a load that does not need to operate in the case of the failure is stopped. Further, the controller controls (the switch 137 and the switch 221) such that the electric power is supplied to the loads 140 to 160 (first load) after the voltage of the sub DC-DC converter 210 is normal.

With this control, in a case where the main DC-DC converter 110 fails (stops) due to a malfunction or the like, the possibility that the electric power supply capability of the sub power supply 200 for executing the degraded travel is insufficient is reduced. In addition, it is possible to prevent the auxiliary battery 120 from being overcharged by the electric power supplied from the sub power supply 200.

### Application

In a case where the sub power supply 200 (or 300) is added to the vehicle electric power system 100, a part of the loads 140 to 160 connected to the main power distribution control unit 130 may be connected to the sub power distribution control unit 220 (or 320). In addition, a part of the second loads 230 to 250 connected to the sub power distribution control unit 220 (or 320) of the sub power supply 200 (or 300) may be connected to the main power distribution control unit 130. Such a replacement of the load can be optionally performed according to the mounting position or the mounting location of the load in the vehicle.

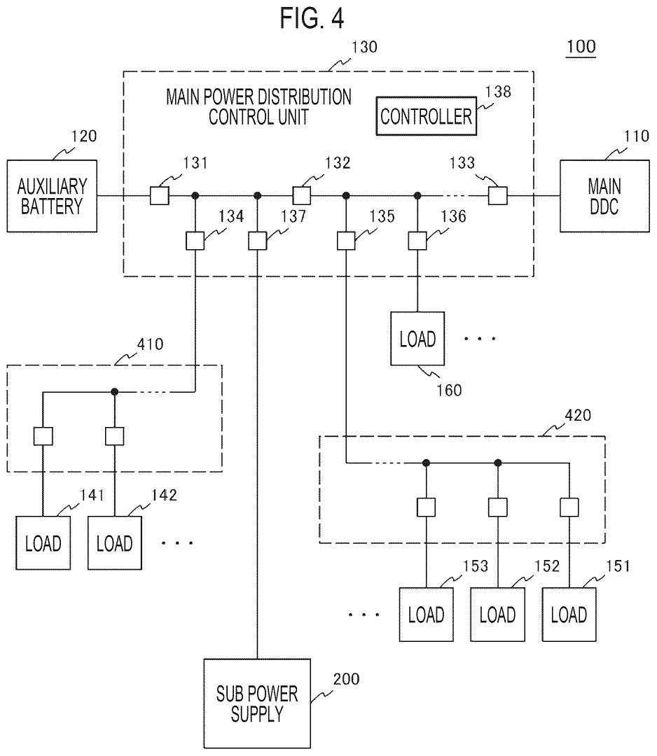

In addition, the vehicle electric power system 100 according to the present embodiment can be connected to the load of the zone configuration as shown in FIG. 4. In the zone configuration illustrated in FIG. 4, the load 140 connected to the main power distribution control unit 130 (zone 1) is replaced with the loads 141, 142 connected to the power distribution control unit 410 (zone 2). Further, the load 150 connected to the main power distribution control unit 130 (zone 1) is replaced with the loads 151, 152, 153 connected to the power distribution control unit 420 (zone 3). The vehicle electric power system 100 according to the present embodiment can be applied to such a load of the zone configuration.

The vehicle electric power system according to the present disclosure can be used for a vehicle that performs the degraded travel with electric power of a sub power supply system in a case where a failure occurs in a main power supply system.

What is claimed is:

1. A vehicle electric power system that supplies electric power to a load mounted in a vehicle, the vehicle electric power system comprising:
a main DC-DC converter connected to a first load that is connected to a main power supply system, the main DC-DC converter being configured to supply electric power to the first load;
an auxiliary battery connected to the first load, the auxiliary battery being configured to supply electric power to the first load;
a sub DC-DC converter connected to a second load that is connected to a sub power supply system, the sub DC-DC converter being configured to supply electric power to the second load;
a first switch and a second switch provided in series between the main power supply system and the sub power supply system; and
a controller configured to control the first switch, the second switch, and the sub DC-DC converter, wherein, in a case of a failure of the main DC-DC converter, the controller stops a load that is not to operate in the case of the failure and controls the first switch and the second switch such that the electric power is supplied to the first load after a voltage of the sub DC-DC converter is normal.

2. The vehicle electric power system according to claim 1, wherein the controller is configured to
control the second switch in a state in which the first switch on the main power supply system side is turned off to determine whether a voltage control abnormality, a disconnection abnormality, or a ground fault abnormality of the sub DC-DC converter is present, and
cause the first switch and the second switch to conduct when determination is made that none of the voltage control abnormality, the disconnection abnormality, or the ground fault abnormality is present.
